(19) United States
(12) Patent Application Publication
(10) Pub. No.: US 2001/0034786 A1
(43) Pub. Date: Oct. 25, 2001

(54) Method ane system for streaming media data in heterogeneous environments

(75) Inventors: Sascha Baumeister, Stuttgart (DE); Thomas Michael Raith, Ditzingen (DE); Ephraim Feig, San Diego, CA (US)

Correspondence Address: GAIL H. ZARICK, IBM CORPORATION, INTELLECTUAL PROPERTY LAW DEPT., P.O. BOX 218, YORKTOWN HEIGHTS, NY, 10598, US

(73) Assignee: IBM

(21) Appl. No.: 09/803,513

(22) Filed: Mar. 9, 2001

(30) Foreign Application Priority Data
Mar. 15, 2000 (EP) 00105507.8

(51) Int. Cl. G06F 7/00; G06F 15/16; G06F 17/30

(52) U.S. Cl. 709/231; 707/10

(57) ABSTRACT

The present invention discloses a new method and system for streaming media data in a heterogeneous network environment. In addition to existing standard streaming products, e.g. standard Media Player and Stream Server, a Stream Server Portal which controls a set of Stream Servers is provided by the present invention. The Stream Server Portal offers a service called prepareStreaming to applications which returns the streaming meta data necessary to initiate streaming for given media instances.

The Stream Server Portal enables generation of streaming meta data necessary to initiate streaming on the fly as part of executing a prepareStreaming request. This completely removes the need to store and maintain the streaming streaming meta data and solves the problems associated with it. Furthermore, the Stream Server Portal allows transfer of media data to a stream server machine transparently as part of executing a prepareStreaming request. This removes the constraint of maintaining media data on the same machine as the stream server software and solves the problems this creates for certain server platforms. The Stream Server Portal can minimize additional network traffic by maintaining a cache of media data already transferred. The Stream Server Portal also allows a choice among available stream servers, to stream a particular media as part of executing a prepareStreaming request. This removes the need for companies to maintain proprietary stream server software, as the Stream Server Portal shields the application requiring streaming from knowing the specifics about, and from storing and maintaining streaming meta data. A preferred embodiment of the present invention discloses the use of an additional Stream Server Controller when the Stream Server Portal may choose among several Stream Servers.

### FIELD OF THE INVENTION

The present invention relates to a method and system for streaming media data by using standard streaming products in a heterogeneous network environment, especially in environments which do not support existing standard streaming products.

### BACKGROUND OF THE INVENTION

New media data (e.g. audio or video data) extend traditional computer data formats into more natural data formats for the interaction of humans and computers by incorporating images, motion pictures, voice, audio, and video. Leading market, business, social, and technical indicators point to the growing importance of this digitally recorded content. By 2003, new media data is expected to eclipse structured data in sheer volume.

Storing, managing, rendering and integrating these digital media data into the information management system and integrating these media data seamlessly into business applications yield significant competitive advantages and the opportunity for new markets, new customers, and new services. One key characteristic of new media data is the huge variety of its size. New media data sizes can span from a few kilobytes for image data to many gigabytes for high resolution video data. Unfortunately, the comparably huge size of at least audio and video media has the drawback that unbearable latency times occur when such media is downloaded to a client to be rendered afterwards. Therefore, a technique called streaming was developed for playing audio or video immediately as it is downloaded from the Internet, rather than storing it in a file on the receiving computer first. Streaming is accomplished by way of web browser plug-ins (e.g. so called Media Players), which decompress and play the media data in real time; a fast computer and a fast connection are required for accomplishing streaming.

Generally, streaming requires two components to interact: first, there must be a Stream Server which resides on a server and is responsible for reading the media data and to send it through the network in parallel. Also, there must be a Media Player which resides on a client and is responsible for receiving the media data from the network and for rendering it in parallel.

The way streaming technology is realized today, media players are only able to stream in conjunction with a stream server built by the same company. This is either because completely proprietary wire protocols are used between the media player and the stream server, or because proprietary add-ons are used to the standard RTP/RTPS wire protocols. Also, Stream Servers are in general only able to stream media data that is stored on a hard disc of the machine running the Stream Server software. Finally, in order to initiate streaming, a file is required that contains a pointer to the media data to be streamed, the TCP/IP hostname of the stream server machine and the port the stream server software listens to. Such a file is commonly referred to as streaming meta data or meta file. The format of such streaming meta data is again proprietary to the kind of Stream Server used. Typical sample streaming meta data for the RealNetworks G2 server (“.ram” file) looks as follows:

rtsp://9.164.184.12:200/media/videos/video1.rv

rtsp://9.164.184.12:200/media/videos/video2.rv

Streaming meta data for other stream servers could include more specific information.

The constraints above cause problems for enterprises that want to utilize streaming technology: As the media data has to be stored on the same machine that runs a particular Stream Server software, and as each Stream Server software product is only available for some server platforms, companies cannot choose freely when deciding on a server platform anymore. For example, this means that companies that want to use the RealNetworks Stream Server/Player cannot store their media data on S/390 servers anymore, because the RealNetworks product is not available on this particular platform.

Unfortunately for S/390, RealNetworks is the market leader in the streaming business with about 90% market share, and it is not cost effective to port the application to the platform.

Streaming meta data has to be stored and maintained for each combination of media data and Stream Server to be used to stream this media data. As these streaming meta data contain the TCP/IP hostname of the Stream Server machine, this creates a maintenance problem once the stream server hostname changes for some reason, as now the streaming meta data affected have to be extracted from the data store and in the worst case manually altered. The same is true when media data is to be relocated to another machine for administrative reasons, as the media data contains the file name and location of the media data.

If a company merges with or buy other companies, it would not be useful for the company to maintain a single strategic stream server software. This means that over time when the media of the merged companies are shared, several different streaming meta data have to be maintained for each single media, increasing the administrative costs and the architectural impact the utilization of streaming technology has.

As streaming meta data contains pointers to the media data, the referential integrity of the data store cannot be guaranteed without special architectural means in the application layer.

### SUMMARY OF THE INVENTION

It is an object of the present invention to reduce maintenance problems with streaming meta data.

Furthermore, it is an object of the present invention to provide a streaming architecture for media data which allows a platform independent use of platform specific stream servers.

These objects have been solved by introducing a Stream Server Portal that controls a set of stream servers known to it. The Stream Server Portal offers a service called prepare Streaming to applications which returns the streaming meta data necessary to initiate streaming for given media instances.

This allows the Stream Server Portal to use the Stream Servers it knows to generate the streaming meta data necessary to initiate streaming on the fly as part of executing a prepare Streaming request. This completely removes the need to store and maintain the streaming meta data and solves the problems associated with it.

This also allows the Stream Server Portal to transfer media to a Stream Server machine transparently as part of executing a prepare Streaming request. This removes the constraint of media data to be maintained on the same machine as the Stream Server Software and solves the problems this creates for certain server platforms. The Stream Server Portal can minimize any additional network traffic by maintaining a cache of the media data already transferred.

This also allows the Stream Server Portal to choose among available stream servers (even from different makers) in order to stream a particular media as part of executing a prepareStreaming request. This removes the need for companies to keep proprietary stream server software, as the Stream Server Portal shields the application requiring streaming from knowing the specifics about, and from storing and maintaining streaming meta data.

### BRIEF DESCRIPTION OF THE DRAWINGS

These and other features of the present invention will become apparent from the accompanying detailed description and drawings, wherein:

FIG. 1 shows prior art streaming products;

FIG. 2 shows the basic streaming architecture of the present invention;

FIG. 3 shows a preferred implementation of the streaming architecture as shown in FIG. 2; and

FIG. 4a/b is a flow diagram explaining a preferred embodiment of the method of the present invention.

### DETAILED DESCRIPTION OF THE PREFERRED EMBODIMENT

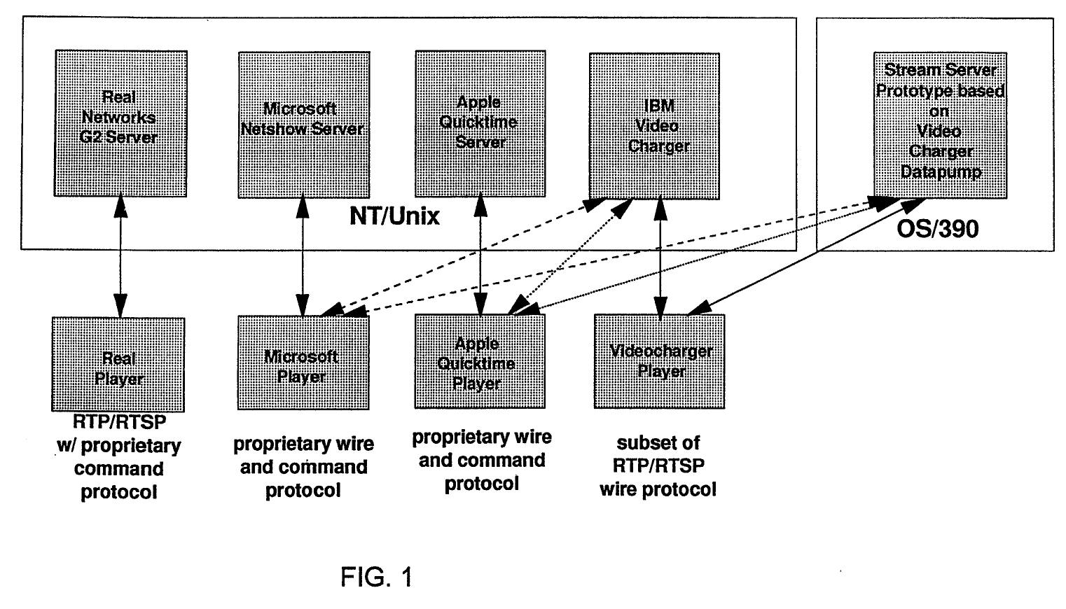

In FIG. 1, prior art streaming products of different companies are shown. Each company offers its own Stream Server as well as Media Player belonging hereto. Normally Stream Servers are not compatible with Media Players developed by others.

Stream Server products are only available for certain platforms. For example, the RealNetworks Stream Server/Media Player which has a market majority is not available for the IBM S/390 platform.

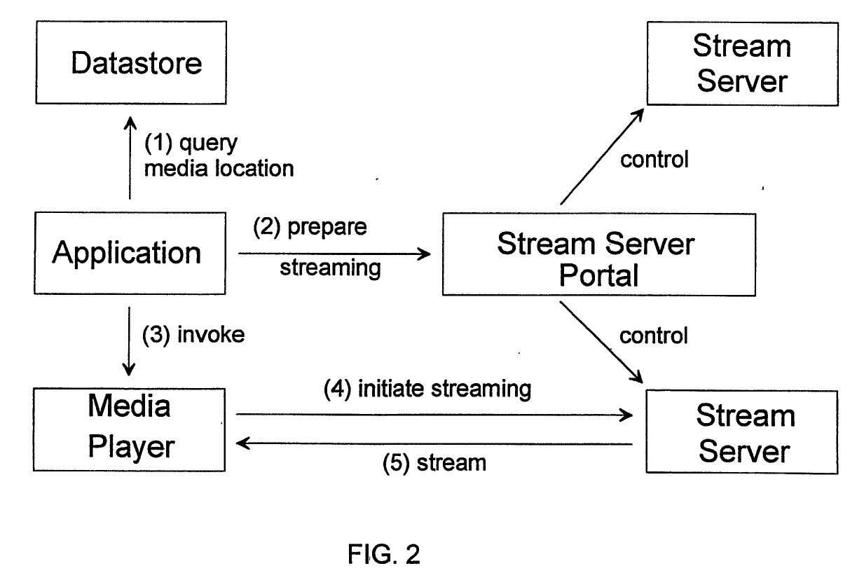

FIG. 2 shows the basic architecture of the present invention. The architecture comprises a data store for storing media data, an application for accessing media data and for invoking Media Player, a Stream Server Portal for receiving calls for preparing streaming of media data, a Media Player for initiating streaming and rendering of media data and Stream Servers for executing streaming of media data. The data store may be any available standard database like IBM DB2. The Stream Server/ Media Player may be any standard streaming product as currently available on the market like RealNetworksServer/Player, MicrosoftNetshowServer/Player, AppleQuicktime/Player, IBM Videocharger/Player.

It is an essential aspect of the present invention that neither the standard Stream Server nor the standard Media player need any adaptation for using in the present invention.

The present invention is primarily directed to the Stream Server Portal (Stream Server Controller). The Stream Server Portal manages communication between the single components of the architecture. In particular, the Stream Server Portal receives the prepare streaming request, which contains location of the media data to be streamed, selects the appropriate Stream Server if more than one is available, initiates transfer of media data to be streamed to the selected Stream Server if necessary (cache), and returns the location of the media data and the selected Stream Server (streaming meta data) to the application which invokes the Media Player for initiating streaming based on the streaming meta data.

In a preferred embodiment, the above basic architecture uses the method steps of:

1. The application queries the location of a media, for example a URL, from a data store, for example a relational database like IBM DB2. As far as the application is part of the media player itself, the query may be initiated by the media player directly. In an alternative embodiment, the address information of the media data is already available by the application without starting a query via a local call or remote call to a data store.

2. The application calls the preparestreaming service of the Stream Server Portal, passing the location (address) of the media and the kind of renderer it wants to use. The Stream Server Portal chooses a Stream Server that is able to stream the media to the renderer, transfers the media to the stream server if necessary, uses the Stream Server to generate the streaming meta data needed to initiate the streaming, and returns the streaming meta data to the application.

3. The application invokes the media player, for example Real Player, and passes the streaming meta data it receives from the Stream Server Portal.

4. The media player initiates the streaming with the Stream Server the Stream Server Portal chooses, for example RealNetworks G2 Server.

5. The Stream Server starts to stream the media content to the media player which renders it in parallel.

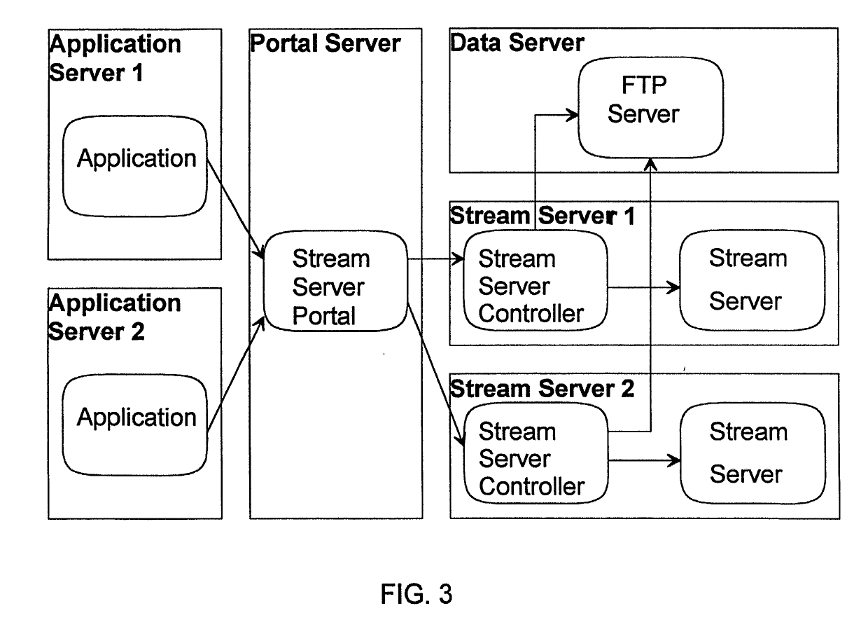

FIG. 3 shows a preferred implementation of the streaming architecture as shown in FIG. 2.

The most significant difference between FIG. 3 and the basic architecture of FIG. 2 is that the independent Stream Servers illustrated in FIG. 2 are integrated in FIG. 3. The integration of these Stream Servers into the basic architecture without adapting them has been achieved by a separation of the functionality of the Stream Server Portal into two separate function components. (1) a Stream Server Portal, and (2) a Stream Server Controller for each Stream Server. Both components may be installed on different servers as shown in FIG. 3.

The Stream Server Portal component is mainly responsible for choosing a suitable Stream Server Controller based on the Stream Server controller it knows. This decision can be based on the ability of the related Stream Server to stream the type of media at all, the cache content of the stream server controller, the current utilization of the associated Stream Server, the locality of the associated Stream Server to the client request, etc.

Furthermore, the Stream Server Portal basically offers a prepare streaming service allowing to pass the location of the media data to the Stream Server to be selected by the Stream Server Portal.

The Stream Server Controller is mainly responsible for checking whether the media data requested by the application are currently stored in its cache. If not, the Stream Server controller initiates a file transfer of the media data from the data store to the cache of the Stream Server Controller via FTP (File Transfer Protocol). Afterwards, the stream server controller generates streaming meta data containing the information necessary to initiate streaming of the media data by program or application and returns it via the Stream Server Portal to the application.

The implementation in FIG. 3 shows a preferred embodiment of the Stream Server Portal in a network environment using different Stream Servers. The Stream Servers, media data, Stream Server Portal and the appropriate applications are stored/installed on different servers. The protocol for calling streaming service from the Stream Server Portal initiated by the application may be RMI (Remote method invocation protocol used for Java environments) or IIOP (Remote method invocation protocol used for CORBA) or RPC (Remote Procedure Protocol)or HTTP (used in the Internet environment). This applies accordingly to the communication between the Stream Server Portal and the Stream Server Controllers.

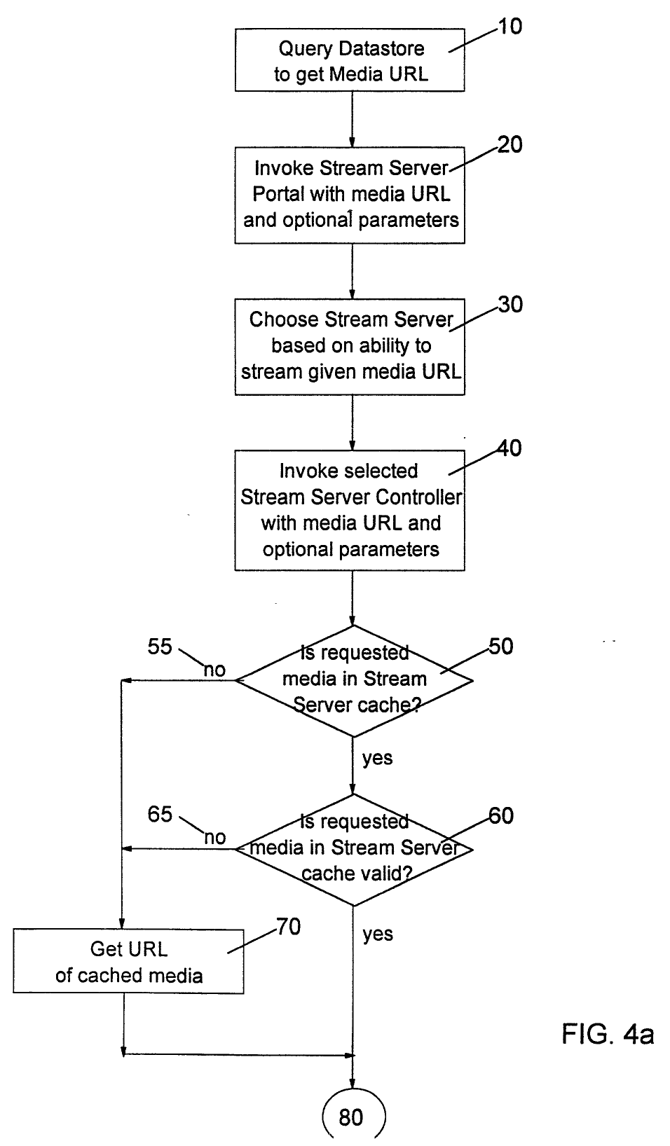

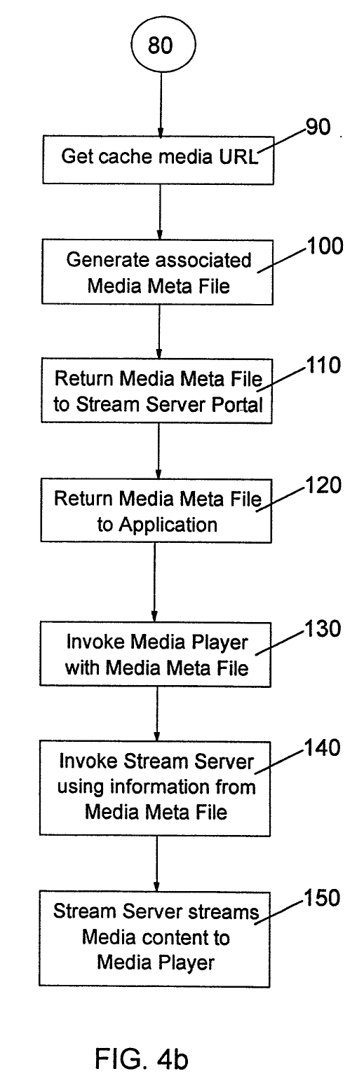

FIG. 4a/b is a flow diagram explaining a preferred embodiment of the method of the present invention. The method may be carried out by an architecture as shown in FIG. 3. It is assumed that the media data are stored in a datastore, e.g., a data base such as, for example, IBM DB2.

The media data may be accessed via their address information. For example, the address information may be a URL (Uniform Resource Locator) when the media data is stored on an Internet server. The URL is an Internet address which tells a browser where to find an Internet resource.

Normally, a program or application is used to initiate a query to get the address information of the media data to be streamed (10). In this case the same programs may be used to invoke the Media Player as well as to issue the query.

After causing the address information of the media data to be streamed, the program or the Media Player itself invokes the Stream Server Portal and passes at least the address information of the media data to the Stream Server Portal (20). Optionally, additional information such as the Media Player/Stream Server type, security information or client information may be passed to the Stream Server Portal.

Based on the information the Stream Server Portal receives from the program or Media Player, a suitable Stream Server will be chosen (30). The Stream Server Portal invokes a Stream Server Controller related to the selected Stream Server and passes the address information of the media data and optionally additional information to it (40).

The Stream Server Controller examines whether the requested media data is already stored in the cache of the Stream Server system (Stream Server Controller system) or in a cache of the network system (50). If yes, then the Stream Server Controller additionally validates the media data (60) stored in the cache. Validation means that media data to be streamed and stored in the cache have the same content (Validation of data integrity). If the requested media data stored in the cache is valid, that means media data stored in the datastore and media data stored in the cache are identical (80). The address information of the requested media data stored in the cache is used by the Stream Server Controller (90). To secure the integrity of media data between cache and datastore, optionally the Stream Server Portal or the Stream Server Controller compares the size of the media data and the last update time stamp of both and initiates a transfer of the media data from the datastore to the cache if an update has been detected. In case the cache does not contain the requested media data (55), the Stream Server Controller initiates an FTP (File Transfer Protocol) using the address information (70) and, optionally, security information received from the Stream Server Portal for transferring the requested media data from the datastore to the cache of the Stream Server Controller system or to a other storage media accessable by the Stream Server Controller (90). This applies accordingly when the requested media data stored in the cache is not valid (65).

After obtaining the cache address information of media data (90), the Stream Server Controller generates streaming meta data (100), which contains at least the cache address information of the media data and the address of the Stream Server selected by the Stream Server Portal. The Server Controller then returns the streaming meta data (110) via the Stream Server Portal (120) to the program or application. In case there is no application or program available, or the program or application is part of the Media Player, the streaming meta data may be returned to Media Player directly. The program or application invokes the Media Player with the streaming meta data received from the Stream Server Controller (130). Then, the Media Player invokes the Stream Server by using information of the streaming meta data (140).

The Stream Server streams the media data to the Media Player by streaming systems (150) in a manner known to those of ordinary skill in the art.

The inventive Stream Server Portal is believed to be useful for every kind of software that utilizes streaming in an enterprise environment. Examples of the kinds of applications which may utilize the Stream Server Portal include, but are not limited to: applications utilizing streaming in a centric programming model; sample Java Servlets and CICS/IMS OLTP transactions; applications utilizing streaming in a distributed programming model, such as, for example, Java Applets Business Objects modeling media, or, for example, Business Applications utilizing Java Enterprise Media Beans Business in categories like ERP (Enterprise Resource Planning) or SCM (Supply Chain Management), with the need to integrate streaming technology.

What is claimed is:

1. A method for streaming media data by a streaming system which contains at least a Stream Server resided on a server system for reading and sending media data in parallel to a Media Player, the Media Player residing on a client system for receiving and rendering media data in parallel and a Stream Server Portal for preparing streaming, whereby media data is stored in a datastore, comprising at least the steps of:
receiving address information of the media data to be streamed by the Stream Server Portal;
selecting suitable Stream Server for the Media Player by the Stream Server Portal;
initiating transfer of the media data from the datastore to a server system on which the Stream Server selected by the Stream Server Portal is installed;
generating streaming meta data containing at least address information of the media data stored in the server system selected by the Stream Server Portal and address information of the Stream Server; and
passing the streaming mete data to the Media Player.

2. The method of claim 1, wherein the address information of the media data to be streamed is provided by an application or program or by the Media Player.

3. The method of claim 1, wherein the address information additionally includes information relating at least one of: the type of the Media Player/Stream Server and security information and client system information.

4. The method of claim 1, wherein the Stream Server Portal selects a suitable Stream Server based on the address information provided by the application.

5. The method of claim 1, wherein the step for initiating transfer of the media data from the data store to the Stream Server selected by the Stream Server Portal is accomplished only if the media data to be streamed is not already stored on a storage media of the Stream Server selected by the Stream Server Portal.

6. The method of claim 5, wherein the step for initiating transfer of the media data from the data store to the Stream Server selected by the Stream Server Portal is not accomplished if the media data to be streamed are stored on the storage media of the Stream Server selected by the Stream Server Portal and the data integrity between of the media stored on the storage media and the datastore is given.

7. The method of claim 6, wherein any update of the media data of the datastore stored in the storage media of the Stream Server initiates a file transfer of the updated media data from the datastore to the storage media of the Stream Server.

8. The method of claim 1, wherein the streaming meta data is passed from the Stream Server via the Stream Server Portal to the application or Programm.

9. The method of claim 1, wherein the streaming meta data is passed from the Streamer Server to the Media Player directly.

10. The method of claim 1, wherein the storage media is a cache.

11. The method of claim 1, wherein the step for initiating transfer of the media data is accomplished by an additional separate Stream Server Controller allocated to each Stream Server, whereby the Stream Server Controller and the Stream Server are installed on the same server system.

12. The method of claim 11, wherein the step for generating the streaming meta data is accomplished by the separate Stream Server Controller.

13. The method of claim 11, wherein the step for generating the streaming meta data is accomplished by the Stream Server.

14. The method of claim 1, wherein transfer of the media data is carried out via File Transfer Protocol.

15. The method of claim 1, wherein the datastore is installed on a server system different from the Stream Server system.

16. The method of claim 1, wherein the Media Player initiates streaming of the media data from the
Stream Server by using the information contained in the streaming meta data.

17. A system for streaming media data comprising:
a Stream Server for reading and sending media data in parallel to a Media Player;
a Media Player for receiving and rendering the media data in parallel;
a Stream Server Portal for receiving at least address information of media data to be streamed and choosing a suitable Stream Server for Media Player to be selected; and
a Stream Server Controller for initiating transfer of the media data from a datastore to a server system where the Stream Server is installed and for generating a streaming meta data containing at least address information of the media data stored in the Stream Server system and address information of the Stream Server selected by the Stream Server Portal.

18. The system of claim 17, wherein the Stream Server, the Stream Server Controller, the Media Player, the datastore containing media data and the Stream Server Portal are installed on different servers and the communication between the servers is accomplished via remote calls.

19. The system of claim 17, wherein the system further includes an application for gathering address information of media data to be streamed and for passing the address information to the Stream Server Portal.

20. The system of claim 17, wherein the server system includes a cache for storing media data.

21. A Streamer Server Portal for use in a method according to claim 1 comprising:
a function component for receiving at least address information for media data to be streamed; and
a function component for choosing a suitable Stream Server for Media Player to be selected.

22. A Stream Server Controller for use in a method according to claim 1, comprising:
a function component for initiating transfer of the media data from the datastore to the server system where the Stream Server is installed; and
a function component for generating streaming meta data and transmitting the streaming meta data to the Media Player.

23. A Stream Server Controller according to claim 22, further comprising:
a function component for checking whether the media data to be streamed is already stored in the storage media of the Stream Server; and
a function component for detecting updates of the media data to be streamed in the datastore and initiating a file transfer of the updated media data from the datastore to the storage media of the Stream Server.

24. A computer program product stored in the internal memory of a digital computer, containing parts of software code to execute the method of claim 1 when the program product is running on the computer.
